(19) United States
(12) Patent Application Publication
(10) Pub. No.: US 2025/0310540 A1
(43) Pub. Date: Oct. 2, 2025

(54) IBC SIGNALING

(71) Applicant: Tencent America LLC, Palo Alto, CA (US)

(72) Inventors: Xin ZHAO, Palo Alto, CA (US); Liang ZHAO, Palo Alto, CA (US); Han GAO, Palo Alto, CA (US); Shan LIU, Palo Alto, CA (US)

(21) Appl. No.: 19/093,050

(22) Filed: Mar. 27, 2025

Related U.S. Application Data
(60) Provisional application No. 63/572,273, filed on Mar. 31, 2024.

(51) Int. Cl. H04N 19/159; H04N 19/176; H04N 19/70

(52) U.S. Cl. CPC H04N 19/159; H04N 19/176; H04N 19/70

(57) ABSTRACT

The various implementations described herein include methods and systems for coding video. In one aspect, a method includes receiving a video bitstream having a plurality of blocks, including a current block. When one or more characteristics of the current block meet one or more criteria: the method includes parsing, from the video bitstream, one or more indicators indicating IBC information; identifying a prediction block for the current block based on the IBC information; and reconstructing the current block using the prediction block. When the one or more characteristics of the current block do not meet the one or more criteria, the method includes decoding the current block without parsing the one or more indicators indicating the IBC information.

### RELATED APPLICATIONS

This application claims priority to U.S. Provisional Patent Application No. 63/572,273, entitled “Intra Block Copy Signaling,” filed Mar. 31, 2024, which is hereby incorporated by reference in its entirety.

### TECHNICAL FIELD

The disclosed embodiments relate generally to video coding, including but not limited to systems and methods for intra block copy (IBC or Intra-BC).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes amongst other things, a set of methods for video (image) compression, more specifically related to conditional signaling of indicators associated with intra block copy information. For example, indicators associated with intra block copy information may be conditionally signaled based on one or more characteristics of a current block (such as a current block size, a superblock size, and a corresponding search region). By conditionally signaling the indicators associated with intra block copy information, compression efficiency may be increased when a smaller local search region is determined to be suitable for finding a prediction block. When the smaller local search region is determined not be suitable for finding a prediction block, signaling overhead may be reduced by not signaling block copy information, while other prediction methods are used to maintain coding accuracy.

In accordance with some embodiments, a method of video decoding is provided. The method includes (i) receiving a video bitstream having a plurality of blocks, including a current block; (ii) when one or more characteristics of the current block meet one or more criteria: (a) parsing, from the video bitstream, one or more indicators indicating IBC information; (b) identifying a prediction block for the current block based on the IBC information; and (c) reconstructing the current block using the prediction block; and (iii) when the one or more characteristics of the current block do not meet the one or more criteria, decoding the current block without parsing the one or more indicators indicating the IBC information.

In accordance with some embodiments, a method of video encoding includes (i) receiving video data comprising a plurality of blocks, including a current block; (ii) when one or more characteristics of the current block meet one or more criteria: (a) encoding the current block using an IBC mode; and (b) signaling, in a video bitstream, one or more indicators indicating IBC information for the current block; and (iii) when the one or more characteristics of the current block do not meet the one or more criteria, not signaling the IBC information for the current block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates an example intra block copy technique in accordance with some embodiments.

FIG. 4B illustrates an example of different intra block copy modes, in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including conditional signaling of indicators associated with intra block copy information (e.g., an IBC on/off flag, a block vector, a block vector predictor, and the like) based on one or more characteristics of the current block. Searching for a prediction block within a smaller local search region may increase coding efficiency of the intra block copy method. However, when one or more characteristics of the current block indicate a reduced likelihood of a suitable prediction block being found in the smaller local search region, the encoder may forgo signaling flags and syntaxes associated with the intra block copy method. If a larger global search region is available for finding a prediction block, a current block may still be encoded using the intra block copy method even when an intra block copy flag is not signaled by the encoder. Otherwise, the intra block copy method is not used to encode the current block. An advantage of conditionally signaling indicators associated with intra block copy information based on one or more characteristics of the current block to reduce signaling overhead (e.g., using less bits when the local search region is determined to be less suitable for finding a prediction block) while preserving coding accuracy, thus improving coding efficiency. Using a smaller local search region to find a prediction block based on the one or more characteristics of the current block improves coding efficiency of the intra block copy method.

### Example Systems and Devices

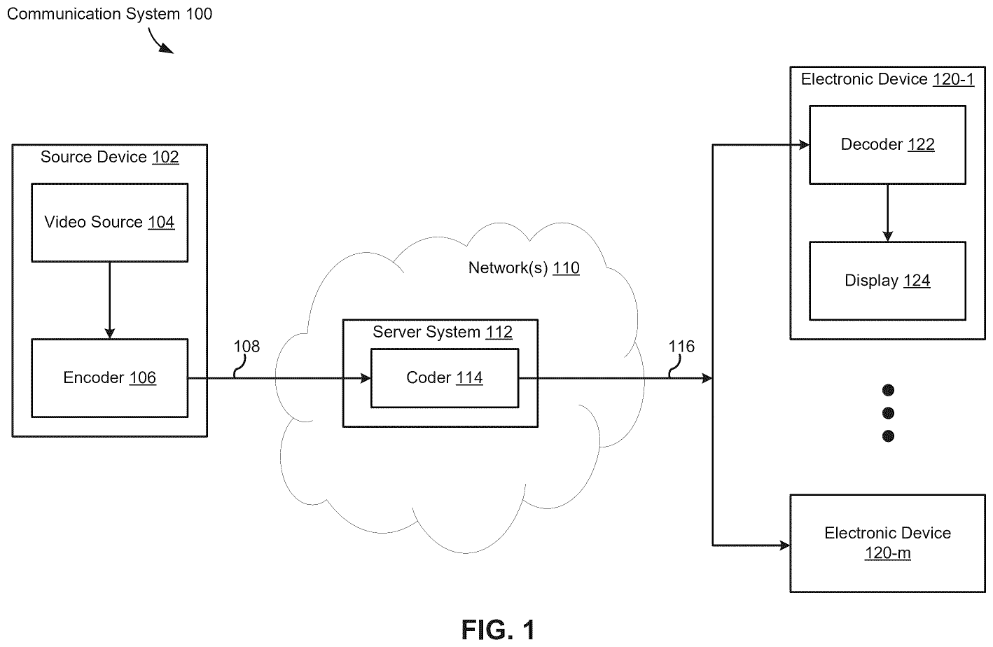

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

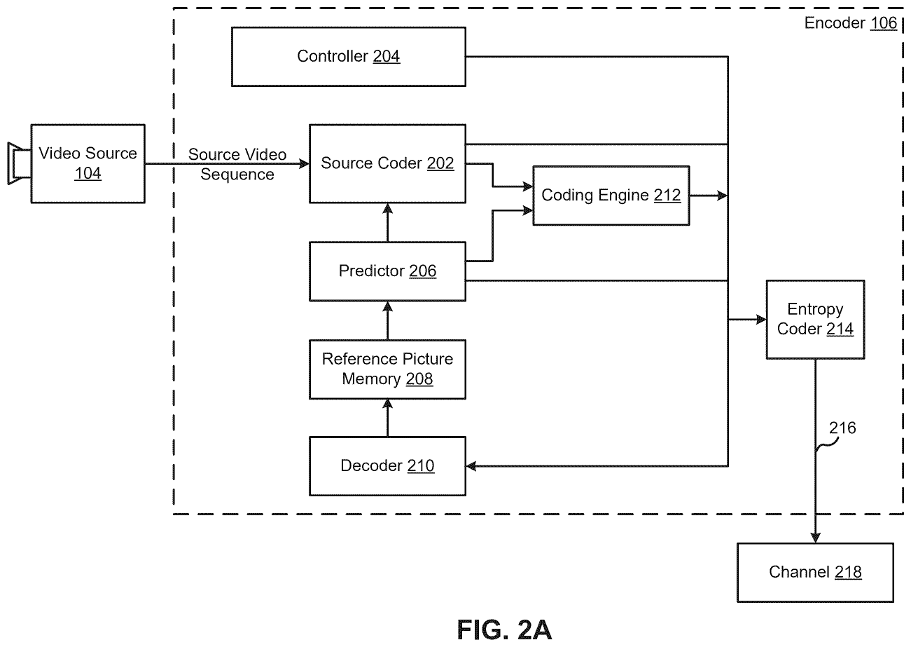

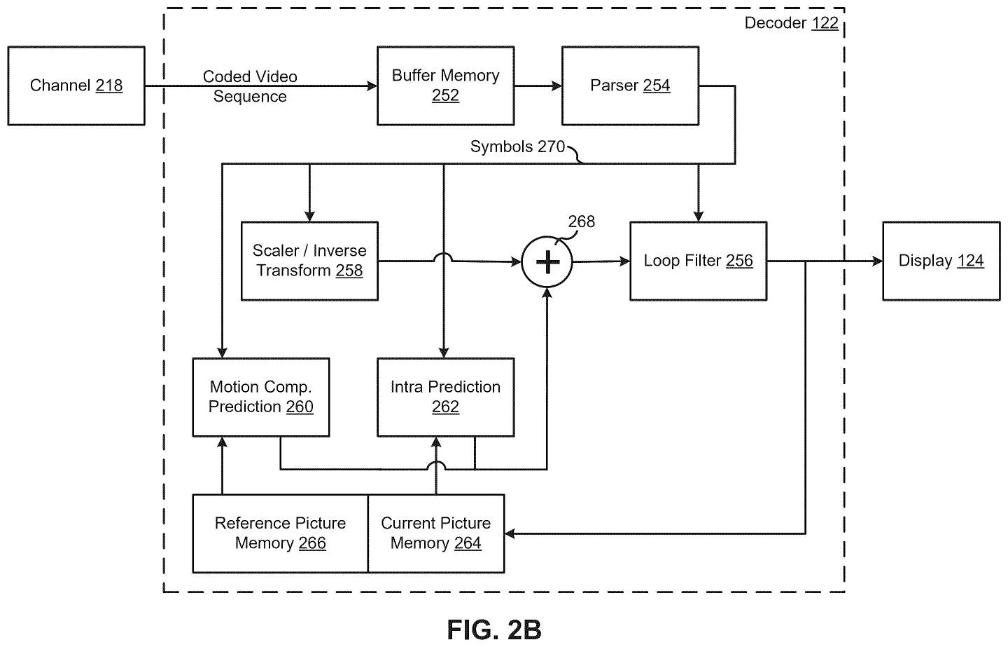

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

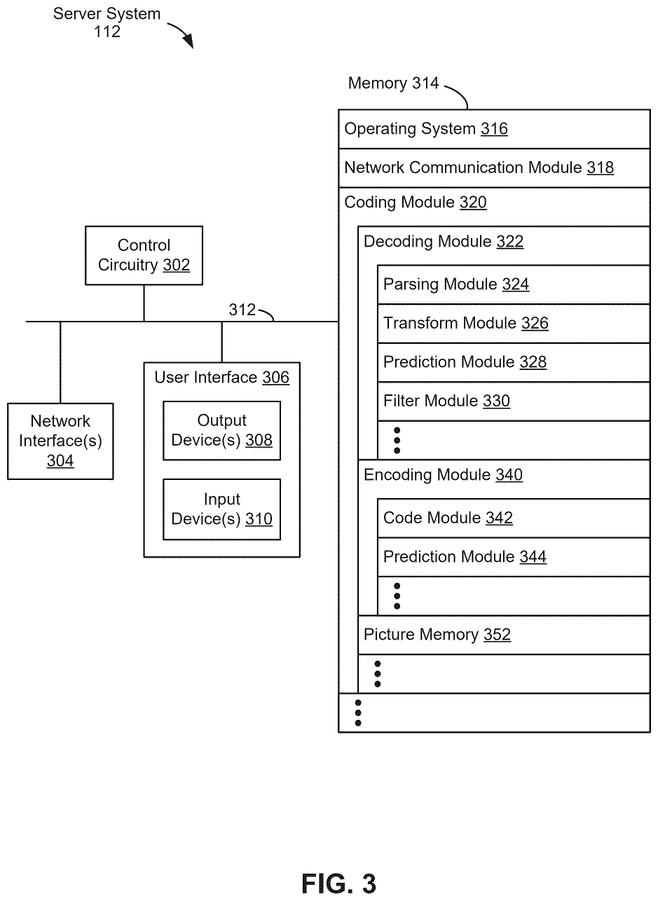

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, example methods for conditional signaling indicators associated with intra block copy information are described below.

An intra block copy method is a method that identifies a prediction block for the current block using a block vector. The block vector is used to identify another block in the same picture of the current block that may be adjacent or non-adjacent to the current block. The block vector may be either explicitly signaled or implicitly derived. When the block vector is explicitly signaled, it is usually referred as the intra block copy method. When the block vector is implicitly derived such as by comparing a template area (a group of neighboring reconstruction samples located adjacent to the block) between the current block and a candidate prediction block, it is usually referred as the intra template matching method.

In some embodiments, “a local search region” refers to a neighboring reconstructed sample region of the current block that can be used to identify a prediction block. For example, the region covered by a block region with a given size (e.g., 64×64) associated with the current block can be a local search region. A global search region, as used herein, may refer to a reconstructed sample region that is further way from the current block that can be used to identify a prediction block. For example, the region that is beyond an adjacent block region with a given size (e.g., all the reconstructed sample region that is beyond the two previously coded superblock (or referred as coding tree block)).

A “superblock size” may refer to the biggest coding block size applied for coding an image/video picture or a video sequence. Block size or region size may refer to the block/region width and/or height, block/region area size, number of samples in the block/region, max (or min) between block/region width and height, and/or block/region aspect ratio.

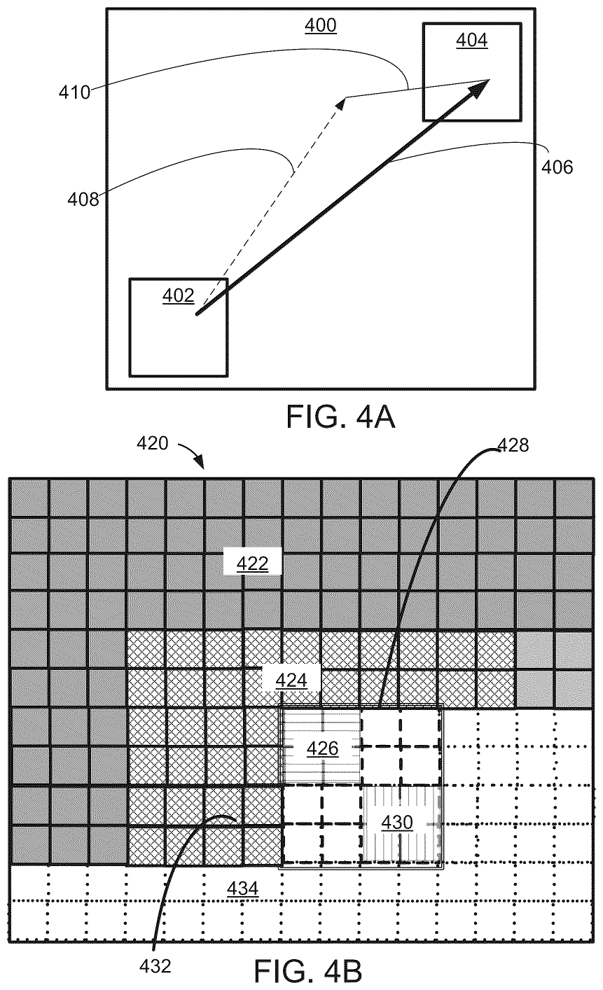

FIG. 4A illustrates an example of an intra block copy technique. In this example, the intra block copy technique includes identifying, via a predicted block vector 408, a prediction block 404 within the same picture 400 as a current block 402. FIG. 4A shows an example in which the prediction block 404 is non-adjacent to the current block 402. In some embodiments, the prediction block 404 is adjacent to the current block 402. In some embodiments, the prediction block vector 408 is selected from a list of candidate block vectors. The list of candidate block vectors may be populated by block vectors used in neighboring blocks and/or block vectors from a block vector bank. A block vector predictor index may be signaled to indicate which candidate block vector in the candidate list is used to predict the block vector for the current block 402.

In some embodiments, a block vector difference (BVD) 410 represents the difference between the predicted block vector and an actual block vector 406, which is the vector between corresponding portions of the current block (e.g., current block 402) and the prediction block (e.g., prediction block 404). While the BVD 410 depicted in FIG. 4A has components along both the horizontal and vertical dimensions, BVD may extend along a single dimension or span two or more dimensions. In some embodiments, the BVD 410 may include information representing a magnitude of a block vector difference and/or a direction of the block vector difference, one or both of which may be signaled in the bitstream as intra block copy information or syntaxes.

FIG. 4B illustrates an example of different intra block copy modes, in accordance with some embodiments. FIG. 4B illustrates an example picture 420 having a number of samples. As an example, the dark gray samples in a global search region 422 and the cross-hatched samples in a local search region 424 both correspond to reconstructed samples in the picture 420. In some embodiments, a prediction block (e.g., similar to the prediction block 404 in FIG. 4A) for a current block 426 (e.g., similar to the current block 402 in FIG. 4A) in a superblock 428 is searched from among the reconstructed samples. The superblock 428 is illustrated schematically in FIG. 4B and the number of dashed line squares does not correspond to the actual number of samples. The superblock 428 may be, for example, 128×128, 64×64, or another size. The superblock 428 may be partitioned into smaller coding blocks, for example, the current block 426 and a coding block 430.

In some embodiments, searching for a prediction block from among the coding blocks encompassing all the available reconstructed samples requires more processing time than searching a local search region only. In some embodiments, the reconstructed samples closest to the current block 426 include more similar information content as the current block 426 (e.g., in scenarios where the picture 420 includes more localized information such as localized texture), and searching for the prediction block in the local search region 424 may be more time efficient and may provide a more suitable prediction block. For example, characteristics of the current block 426 may reflect the informational content of the current block. The current block may be smaller (e.g., 8×8, 16×16, 32×32, etc.) if the current block contains more textured information. The current block may be larger (e.g., 64×64 etc.) if the information content within the current block is smoother (e.g., not much texture).

In some embodiments, a first intra block copy mode includes searching for the prediction block in the more restricted, smaller local region 424, instead of the larger global region (e.g., the sum of the region 422 and 424, or only the region 422). In some embodiments, a second intra block copy mode includes searching for the prediction block in the larger global region that includes at least the region 422. In some embodiments, the second intra block copy mode (e.g., searching with the larger global region) is a default intra block copy mode when the first intra block copy mode is not available (e.g., no searching for the prediction block is done within the smaller local region 424, but the intra block copy method is still used to encode the current block).

In some embodiments, one or more flags and/or syntaxes that indicate the usage of the intra block copy method may be signaled into the bitstream by an encoder. For example, an intra block copy on/off flag may be signaled to indicate whether the intra block copy method is to be used for a coding block. Intra block copy related parameters such as a block vector (e.g., 406), a block vector predictor index (e.g., indicating which block vector from a list of candidate block vectors is to be used) may also be signaled. In some embodiments, whether the intra block copy on flag is signaled (e.g., to indicate usage of the intra block copy method) may depend on one or more of: a coding block sizes, a superblock size, a selection of a search region, and/or a relative position of a current block relative to an associated block of a given size.

In some embodiments, a block size threshold s₂ is derived based on a given superblock size (e.g., denoted as s₀) and a size of the local search region (e.g., denoted as s₁). In some embodiments, the size of the local search region s₁ may vary depending on a location of the current block. For example, for a current block at an edge of the picture 420, the local search region s₁ may be smaller than for a current block in an interior of the picture 420. In some embodiments, whether the first intra block copy mode is used or not depends on a size of the current block. In some embodiments, when the current block is smaller than or equal to the block size threshold s₂, the flags and syntaxes indicating the usage of intra block copy method are signaled to indicate that the intra block copy method is used to encode the current block. In some embodiments, the syntaxes further indicate whether the prediction block is to be searched within the local search region (e.g., the region 424) or within both the local search region (the region 424) and the larger global search region (e.g., the region 422).

In some embodiments, when the current block is larger than the block size threshold s₂, the flags and syntaxes are not signaled. For example, in such situations, when the current block is larger than the block size threshold s₂, there may not be a sufficient number of reconstructed samples and/or potential prediction blocks such that the likelihood of finding a good prediction block may be lower. As a result, if intra block copy is used to encode the current block in such situations, then the local search region 424 is disable and searching for the prediction block is conducted only in the global search region. In some embodiments, intra block copy is not be used to encode the current block, and other prediction modes (e.g., angular prediction modes and/or non-angular prediction modes) are used instead.

In some embodiments, when the intra block copy flags and/or the intra block copy syntaxes are not signaled, the second intra copy block mode (e.g., a prediction block is searched within the global search region 422) is used, by default. In some embodiments, when the intra block copy flags and/or the intra block copy syntaxes are not signaled, the intra copy block method is not used (e.g., the current block uses angular or non-angular intra prediction modes) for the current block.

In some embodiments, the block size threshold s₂ is equal to the local search region s₁, or the block size threshold s₂ is s₁/N, where N is a power of 2, e.g., 2, 4, 8, 16, etc. As an example, s₁ may be 64×64, and the block size threshold s₂ may be derived as 64×64/4 (e.g., N is 4) which corresponds to 32×32. When the current block size is smaller than or equal to 32×32, the flags and syntaxes indicating the usage of intra block copy method are signaled (e.g., indicating the usage of either the first intra block copy mode or the second intra block copy mode). In some embodiments, when the intra block copy flags and/or the intra block copy syntaxes are not signaled, the second intra copy block mode (e.g., a prediction block is searched within the global search region 422) is used, by default. In some embodiments, when the intra block copy flags and/or the intra block copy syntaxes are not signaled, the intra copy block method is not used for the current block (e.g., the current block uses angular or non-angular intra prediction modes).

In some embodiments, the block size threshold s₂ is equal to the smaller of the superblock size s₀ and the local search region s₁ (e.g., also denoted as min(s₀, s₁)). In some embodiments, the block size threshold s₂ is equal to min(s₀, s₁)/N, where N is a power of 2, e.g., 2, 4, 8, 16, etc. As an example, superblock size so may be 32×32, the local search region s₁ may be 64×64, and the block size threshold s₂ may be derived as min(s₀, s₁)/N, which is 16×16 in this example. In such scenarios, when the coding block size (e.g., size of the region 426) is smaller than or equal to 16×16, the encoder signals the intra block copy on flag and intra block copy syntaxes (e.g., a block vector, a block vector predictor index, and/or a block vector difference). In some embodiments, when the intra block copy flags and/or the intra block copy syntaxes are not signaled, the second intra copy block mode (e.g., a prediction block is searched within the global search region 422) is used, by default. In some embodiments, when the flags and/or the syntaxes are not signaled, the intra copy block method is not used (e.g., the current block uses angular or non-angular intra prediction modes).

In some embodiments, the block size threshold s₂ is predefined and set as a fixed value for all video sequences. In some embodiments, the block size threshold s₂ is signaled into the bitstream in one high level syntax, such as sequence header, frame header, slice header and etc.

In some embodiments, when a current block is located at selected relative positions within a block having a pre-defined block size, the encoder does not signal intra block copy related syntaxes (e.g., the encoder forgoes signaling intra block copy related syntaxes). For example, if the current block is located at the top-left of a 64×64 block in a grid of 64×64 blocks (e.g., a partitioning grid) of the current picture, the encoder does not signal intra block copy related syntaxes (e.g., the encoder forgoes signaling intra block copy related syntaxes). In some embodiments, as illustrated in FIG. 4B, the current block 426 is in a top-left portion of the superblock 428, and a search range for a prediction block of the current block 426 would occur in a bottom left portion 432, reducing a likelihood of a good prediction block to be selected. For example, the bottom left portion 432 may be adjacent to an unprocessed region 434 of the current picture 420. As a result, the encoder forgoes signaling intra block copy related syntaxes. In contrast, in some embodiments, for a coding block 430 in a lower right corner of the superblock 428, the search range for the prediction block of the coding block 430 would not be restricted to the bottom left portion 432, and the encoder may signal intra block copy related syntaxes into the bitstream for the coding block 430.

In some embodiments, when the current block size is greater than (or greater than a scaled value of) a reconstructed area size of the associated 64×64 block in the 64×64 partitioning grid of the current picture, the encoder does not signal intra block copy related syntaxes (e.g., the encoder forgoes signaling intra block copy related syntaxes). For example, instead of four full rows of gray reconstructed samples illustrated in the global search region 422 in FIG. 4B, in scenarios where only one or two rows of reconstructed samples are available in the picture 420, and the current block size is greater than an area of at least a portion of the reconstructed samples, the encoder does not signal intra block copy related syntaxes and intra block copy is not used to encode the current block.

In some embodiments, when the global search region (e.g., region 422), or both the local search region (e.g., region 424) and the global search region (e.g., region 422) are applicable for searching of the prediction block, the conditions for signaling intra block copy method related syntaxes may be different from the condition for signaling intra block copy method related syntaxes when only local search region is applicable.

In some embodiments, the signaling of intra block copy related parameters (such as block vector, or block vector difference) may depend on the one or more characteristics of the current block as described above.

In some embodiments, a maximum value of one or more intra block copy related parameters (such as block vector, or block vector difference) may be derived and the signaling of intra block copy related parameters may depend on this max value. For example, there may be an upper limit to the block vector (e.g., block vector is not too large) if searching for the prediction block is conducted in a smaller local region 424. In some embodiments, if searching for prediction blocks in the smaller local search region 424 is disabled (e.g., by the encoder not signaling IBC flags and/or syntaxes), searching for prediction blocks in the global search region 422 may still be allowed if the current block is to be coded using intra block copy. Alternatively, the current block is encoded using non-IBC methods (e.g., angular prediction modes or non-angular prediction modes).

In some embodiments, in some frames, block-level syntax elements, such as flags for block partitioning, transform block partitioning, reference frame indices, motion vector/block vector, prediction mode, EOB, transform skip flags, transform type flags, and the like are not signaled in the bitstream but are instead implicitly derived by a decoding component when such a frame is identified by a separate frame level flag. In some embodiments, prior IBC frame(s) are used as reference with all blocks skipped, and by using zero motion vectors, unless explicitly signaled otherwise.

In some embodiments, a local search area is extended to a local memory of a 128×128 block in luma samples. For example, for a sub-block of size 64×64 or lower, the reconstructed samples in a left superblock, if available, and already coded samples in a current superblock may be used as IBC references. The availability of the reconstructed samples on the left superblock is based on a location of the current 64×64 block. As an example, for a current block within a top left 64×64 sub-block of a current superblock, only already reconstructed samples within the current sub-block, the reconstructed samples of the top right 64×64 sub block, the bottom left 64×64 sub block, and/or the bottom right 64×64sub-block of the left superblock may be used. In another example, for a current block within a top right 64×64 sub-block of a current superblock, only already reconstructed samples within the current sub-block, the reconstructed samples of the top left 64×64 sub block of the current superblock, the bottom left 64×64 sub block, and/or the bottom right 64×64 sub block of the left superblock may be used. In another example, for a current block within a bottom left 64×64 sub-block of a current superblock, only already reconstructed samples within the top left and top right sub-blocks of the current superblock, and/or the reconstructed samples of the bottom right 64×64 sub block of the left superblock may be used. In another example, for a current block within a bottom right 64×64 sub-block of a current superblock, only already reconstructed samples within the sub-blocks of the current superblock may be used.

In some embodiments, IBC derivation is performed as is shown in Table 1 below.

TABLE 1

```
Intra Block Copy Derivation.
static INLINE int allow_intrabc(const COMMON *const cm,
                              const MACROBLOCKD * const xd
#if CONFIG_ENABLE_IBC_NAT
BLOCK_SIZE bsize
#endif //CONFIG_ENABLE_IBC_NAT
){
#if CONFIG_ENABLE_IBC_NAT
  const int w=block_size_wide[bsize];
  const int h=block_size_high[bsize];
  if (w == 64 && h=64) || (w>65 || h>64)) {
    return 0;
}
# endif
#if CONFIG_EXTENDED_SDP
  int cur_region_type= MIXED_INTER_INTRA_REGION;
  if (xd ->mi !=NULL) cur_region_type = xd->mi[0]->region_type;
#endif
#if CONFIG_IBC_SR_EXT
  return (frame_is_intra_only(cm) || cm->features.allow_local_intrabc) &&
#if CONFIG_EXTENDED_SDP Active Preprocessor Block
#endif // CONFIG_EXTENDED_SDP
#if !CONFIG_ENABLE_IBC_NAT
  cm ->features.allow_screen_content_tools &&
#endif //! CONFIG_ENABLE_IBC_NAT
  cm->features.allow_intrabc;
#else Inactive Preprocessor Block
#endif //CONFIG_IBC_SR_EXT
}
```

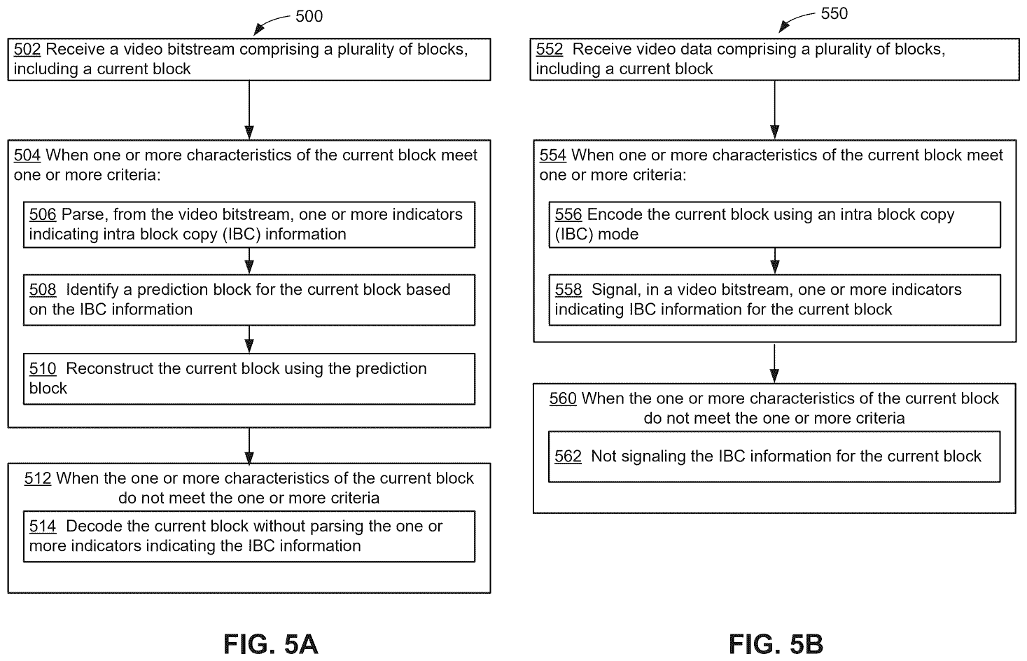

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream (e.g., a coded video sequence) comprising a plurality of blocks (e.g., corresponding to a set of pictures), including a current block. When one or more characteristics of the current block meet (504) one or more criteria: the system parses (506), from the video bitstream, one or more indicators indicating IBC information. The system identifies (508) a prediction block for the current block based on the IBC information, and the system reconstructs (510) the current block using the prediction block. When one or more characteristics of the current block do not meet (514) the one or more criteria: the system decodes (514) the current block without parsing the one or more indicators indicating the IBC information.

In some embodiments, the flags and syntaxes indicating the usage of the intra block copy method, e.g., the intra block copy on/off flag, intra block copy related parameters such as a block vector, a block vector predictor index, are conditionally signaled, and the condition may include parameters relating to the coding block sizes, the superblock size, the selection of search region, and/or the relative position of the current block relative to an associated block of a given size.

In some embodiments, given the superblock size (denoted as s₀) and the local search region size (denoted as s₁), a block size s₂ is derived, only when a coding block is smaller than or equal to this s₂ size, are the flags and syntaxes indicating the usage of the intra block copy method signaled. Otherwise, the flags and syntaxes are not signaled.

In some embodiments, s₂ is equal to s₁, or s₂ is s₁/N, where N is a power of 2, e.g., 2, 4, 8, 16, . . . . For example, s₁ may be 64×64, and s₂ may be derived as 64×64/4, which is 32×32. Only when coding block size is smaller than or equal to 32×32, are the flags and syntaxes indicating the usage of the intra block copy method signaled.

In some embodiments, s₂ is equal to min(s₀, s₁), or s₂ is min(s₀, s₁)/N, where N is a power of 2, e.g., 2, 4, 8, 16, . . . . For example, s₀ may be 32×32, s₁ may be 64×64, and s₂ is derived as min(s₀, s₁)/4, which is 16×16. Only when coding block size is smaller than or equal to 16×16, are the flags and syntaxes indicating the usage of the intra block copy method signaled.

In some embodiments, when the coding block is located in selected relative positions inside a given block size with pre-defined block sizes, the intra block copy related syntaxes are not signaled. As an example, when the current coding block is located at the top-left of the associated 64×64 block in the 64×64 partitioning grid of the current picture, then intra block copy related syntaxes are not signaled.

In another example, when the current coding block size is greater than (or greater than a scaled value of) the reconstructed area size of the associated 64×64 block in the 64×64 partitioning grid of the current picture, intra block copy related syntaxes are not signaled.

In some embodiments, when the global search region, or both the local and the global search region re applicable, the condition for signaling intra block copy method related syntaxes may be different from the condition for signaling intra block copy method related syntaxes when only the local search region is applicable.

In some embodiments, when the global search region, or both the local and the global search region are applicable, the conditional signaling of the intra block copy flags and syntaxes described above are not applied.

In some embodiments, the size of s₂ is set as a predefined and fixed value for all video sequences. In some embodiments, the size of s₂ is signaled into the bitstream in one high level syntax, such as sequence header, frame header, slice header and etc.

In some embodiments, when the flags and syntaxes indicating the usage of intra block copy method are not signaled, intra block copy is not applied for the current block.

In some embodiments, the signaling of intra block copy related parameters (such as block vector, or block vector difference) may depend on the conditions described above As an example, a max value of intra block copy related parameters (such as block vector, or block vector difference) may be derived and the signaling of intra block copy related parameters may depend on this max value.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of blocks (e.g., corresponding to a set of pictures), including a current block. When one or more characteristics of the current block meet (554) one or more criteria: the system encodes (556) the current block using an IBC mode, and the system signals (558), in a video bitstream, one or more indicators indicating IBC information for the current block. When the one or more characteristics of the current block do not meet (560) the one or more criteria: the system does not (562) signal the IBC information for the current block. As described previously, the encoding process may mirror the decoding processes described herein (e.g., the conditional signaling of intra mode copy embodiments described above). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks, including a current block. When one or more characteristics of the current block meet one or more criteria: the method includes (ii) parsing, from the video bitstream, one or more indicators indicating IBC information; (iii) identifying a prediction block for the current block based on the IBC information; and (iv) reconstructing the current block using the prediction block. When the one or more characteristics of the current block do not meet the one or more criteria, the method includes (v) decoding the current block without parsing the one or more indicators indicating the IBC information. For example, flags and/or syntax elements indicating the usage of an intra block copy method (e.g., the intra block copy on/off flag, and/or intra block copy related parameters such as block vector, block vector predictor index, and the like) is conditionally signaled based on one or more of: coding block sizes, the superblock size, the selection of search region (e.g., selecting one of global IBC and local IBC), and/or the position of the current block relative to an associated block of a given size. In some embodiments, in accordance with a determination that the one or more characteristics of the current block meet the one or more criteria, the one or more indicators indicating IBC information are parsed from the video bitstream. In some embodiments, in accordance with a determination that the one or more characteristics of the current block do not meet the one or more criteria, the current block is decoded without parsing the one or more indicators indicating the IBC information (e.g., the system forgoes parsing the one or more indicators).
(A2) In some embodiments of A1, the one or more criteria comprise one or more of: a coding block size of the current block; a size of a superblock corresponding to the current block; a selection of a search region for the current block; and a position of the current block relative to an associated block of a given size.
(A3) In some embodiments of A1 or A2, the IBC information comprises one or more of: an IBC mode flag; a block vector; a block vector predictor index; and a block vector difference. For example, the signaling of IBC-related parameters (such as a block vector, a block vector difference, and/or a block vector precision) is based on whether the one or more characteristics of the current block meet the one or more criteria. In some embodiments, the IBC mode flag indicates whether an IBC mode is enabled for the current block. In some embodiments, the IBC mode flag indicates whether a global or local IBC mode is enabled for the current block.
(A4) In some embodiments of any of A1-A3, decoding the current block without parsing the one or more indicators indicating the IBC information comprises decoding the current block according to a non-IBC mode. For example, the non-IBC mode may be an intra prediction mode (e.g., an angular intra prediction mode or non-directional intra prediction mode). As an example, when the flags and syntaxes indicating the usage of IBC are not signaled/parsed, IBC is not applied for the current block. In some embodiments, decoding the current block without parsing the one or more indicators indicating the IBC information comprises deriving the IBC information based on coded information (e.g., available at the decoder).
(A5) In some embodiments of any of A1-A4, the one or more criteria comprise a size threshold that is based on a superblock size and a local search region size; and the current block meets the one or more criteria when a size of the current block is less than the size threshold. For example, a size threshold, s2, is derived based on superblock size, s0, and a local search region size, s1. For a coding block is smaller than or equal to this s2 size threshold, the flags and/or syntaxes indicating the usage of IBC are signaled, otherwise, the flags and/or syntaxes are not signaled. If the block size is large relative to the superblock size and/or search region, then there may not be enough pixels to search (e.g., in the local search area) to obtain a good candidate. In this case, local IBC should not be used due to the low chance in finding a good candidate. Thus, to save signaling overhead, the system can forgo signaling IBC information. In some embodiments, local IBC is disabled in this circumstance (e.g., the system defaults to using global IBC).
(A6) In some embodiments of A5, the size threshold is equal to the local search region size divided by N, and N is a power of 2. For example, N may be 1, 2, 4, 8, or 16. For example, if s2 is equal to s1 or s1/N, where N is a power of 2. As a specific example, when s1 is 64×64, s2 may be derived as 64×64/4, which is 32×32. In this case, only when the coding block size is smaller than or equal to 32×32, the flags and syntaxes indicating the usage of IBC are signaled. Thus, local IBC is disallowed (disabled) when the block size is larger than s1/N.
(A7) In some embodiments of A5, the size threshold is equal to S/N, where S is equal to the lesser of the superblock size and the local search region size, and N is a power of 2. For example, s2 is equal to min(s0, s1), or s2 is min (s0, s1)/N, where N is a power of 2 (e.g., 2, 4, 8, 16). As a specific example, s0 is 32×32, s1 is 64×64, s2 is derived as min(s0, s1)/4, which is 16×16. In this case, only when coding block size is smaller than or equal to 16×16, the flags and syntaxes indicating the usage of IBC are signaled.
(A8) In some embodiments of A5, the size threshold is a predefined value. For example, the size threshold s₂ is set as a predefined and fixed value for all video sequences.
(A9) In some embodiments of A5, the method further comprises parsing, from the video bitstream, a second indicator indicating the size threshold. For example, the size threshold s₂ is signaled into the video bitstream in a high-level syntax, such as a sequence header, a frame header, or a slice header.
(A10) In some embodiments of any of A1-A9, the one or more criteria comprise a block size criterion and a relative block position criterion. For example, when the coding block is located in selected relative positions inside of a given block with predefined block sizes, the IBC-related syntaxes are not signaled.
(A11) In some embodiments of A10, the relative block position criterion comprises a criterion regarding whether the current block is located at a top-left position in a partitioning grid. For example, when the current coding block is located at the top-left of an associated 64×64 block in the 64×64 partitioning grid of the current picture, then intra block copy related syntaxes are not signaled. In this case, the search area may have a lower chance of yielding a good candidate. The search area may be at the bottom left for a coding block at the top-left, which may result in a lower chance of having a good candidate.
(A12) In some embodiments of A11, the block size criterion comprises a criterion regarding whether a size of the current block is greater than a search area size. For example, when the current coding block size is greater than the reconstructed area size (or a scaled value of the area size) of an associated 64×64 block in the 64×64 partitioning grid of the current picture, then intra block copy related syntaxes are not signaled (e.g., if the search area is not sufficiently large for the block, do not allow local IBC).

(A13) In some embodiments of any of A1-A12, the method further comprises: when a global IBC mode is allowed for the current block, identifying a first set of criteria as the one or more criteria; and when a global IBC mode is not allowed for the current block, identifying a second set of criteria as the one or more criteria. For example, when a global search region, or both local and global search regions are applicable, the conditions for signaling IBC-related syntaxes may be different from the conditions for signaling IBC-related syntaxes when only a local search region is applicable.
(A14) In some embodiments of any of A1-A13, the method further comprises: when a global IBC mode is allowed for the current block, decoding the current block without considering whether the one or more characteristics of the current block meet the one or more criteria. For example, when a global search region, or both local and global search regions are applicable, the conditional parsing of IBC information is not applied. In some embodiments, when the global IBC mode is allowed for the current block, the one or more indicators are parsed from the video bitstream without considering whether the one or more characteristics of the current block meet the one or more criteria.
(A15) In some embodiments of any of A1-A14, the method further comprises deriving a maximum value for an IBC parameter, where the one or more criteria comprise a criterion regarding the maximum value for an IBC parameter. For example, a maximum value for an IBC-related parameter (e.g., block vector or block vector difference) may be derived and the signaling of the IBC-related parameters may depend on this maximum value. For example, if the maximum value for the block vector or block vector difference is too large than a local IBC mode may be disabled.
(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes receiving video data (e.g., a source video sequence) comprising a plurality of blocks, including a current block. When one or more characteristics of the current block meet one or more criteria: the method includes encoding the current block using an IBC mode; and signaling, in a video bitstream, one or more indicators indicating IBC information for the current block. When the one or more characteristics of the current block do not meet the one or more criteria, the method includes not signaling the IBC information for the current block. In some embodiments, when the one or more characteristics of the current block do not meet the one or more criteria, the current block is encoded in a non-IBC mode. In some embodiments, when the one or more characteristics of the current block do not meet the one or more criteria, the current block is encoded in a global IBC mode.
(B2) In some embodiments of B1, the method includes signaling, in the video bitstream, the encoded current block.
(B3) In some embodiments of B1 or B2, when a global IBC mode is allowed for the current block, the method includes identifying a first set of criteria as the one or more criteria. When a global IBC mode is not allowed for the current block, the method includes identifying a second set of criteria as the one or more criteria.
(B4) In some embodiments of any of B1-B3, when a global IBC mode is allowed for the current block, the method includes encoding the current block without considering whether the one or more characteristics of the current block meet the one or more criteria.
(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes obtaining a source video sequence that comprises a plurality of frames, and performing a conversion between the source video sequence and a video bitstream of visual media data according to a format rule. The video bitstream comprises a set of encoded blocks including a current block, and when one or more characteristics of the current block meet one or more criteria, one or more indicators indicating IBC information for the current block. The format rule specifies that, when the one or more characteristics of the current block meet the one or more criteria, the IBC information is to be parsed from the video bitstream, a prediction block is to be identified for the current block based on the IBC information, and the current block is to be reconstructed using the prediction block. In some embodiments, the format rule further specifies that, when the one or more characteristics of the current block do not meet the one or more criteria, the current block is to be decoded without parsing the one or more indicators indicating the IBC information. In some embodiments, the video bitstream does not include the one or more indicators when the one or more characteristics of the current block do not meet the one or more criteria.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A15, B1-B4, and C1 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A15, B1-B4, and C1 above). In some embodiments, a non-transitory computer-readable storage medium stores a video bitstream that is generated by any of the video encoding methods described herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
when one or more characteristics of the current block meet one or more criteria:
parsing, from the video bitstream, one or more indicators indicating intra block copy (IBC) information;
identifying a prediction block for the current block based on the IBC information; and
reconstructing the current block using the prediction block; and
when the one or more characteristics of the current block do not meet the one or more criteria, decoding the current block without parsing the one or more indicators indicating the IBC information.

2. The method of claim 1, wherein the one or more criteria comprise one or more of:
a coding block size of the current block;
a size of a superblock corresponding to the current block;
a selection of a search region for the current block; and
a position of the current block relative to an associated block of a given size.

3. The method of claim 1, wherein the IBC information comprises one or more of:
an IBC mode flag;
a block vector;
a block vector predictor index; and
a block vector difference.

4. The method of claim 1, wherein decoding the current block without parsing the one or more indicators indicating the IBC information comprises decoding the current block according to a non-IBC mode.

5. The method of claim 1, wherein:
the one or more criteria comprise a size threshold that is based on a superblock size and a local search region size; and
the current block meets the one or more criteria when a size of the current block is less than the size threshold.

6. The method of claim 5, wherein the size threshold is equal to the local search region size divided by N, and wherein N is a power of 2.

7. The method of claim 5, wherein the size threshold is equal to S/N, wherein S is equal to the lesser of the superblock size and the local search region size, and wherein N is a power of 2.

8. The method of claim 5, wherein the size threshold is a predefined value.

9. The method of claim 5, further comprising parsing, from the video bitstream, a second indicator indicating the size threshold.

10. The method of claim 1, wherein the one or more criteria comprise a block size criterion and a relative block position criterion.

11. The method of claim 10, wherein the relative block position criterion comprises a criterion regarding whether the current block is located at a top-left position in a partitioning grid.

12. The method of claim 10, wherein the block size criterion comprises a criterion regarding whether a size of the current block is greater than a search area size.

13. The method of claim 1, further comprising:
when a global IBC mode is allowed for the current block, identifying a first set of criteria as the one or more criteria; and
when a global IBC mode is not allowed for the current block, identifying a second set of criteria as the one or more criteria.

14. The method of claim 1, further comprising:
when a global IBC mode is allowed for the current block, decoding the current block without considering whether the one or more characteristics of the current block meet the one or more criteria.

15. The method of claim 1, further comprising deriving a maximum value for an IBC parameter, wherein the one or more criteria comprise a criterion regarding the maximum value for an IBC parameter.

16. A method of video encoding performed at a computing system having memory and one or more processors, the method comprising:
receiving video data comprising a plurality of blocks, including a current block;
when one or more characteristics of the current block meet one or more criteria:
encoding the current block using an intra block copy (IBC) mode; and
signaling, in a video bitstream, one or more indicators indicating IBC information for the current block; and
when the one or more characteristics of the current block do not meet the one or more criteria, not signaling the IBC information for the current block.

17. The method of claim 16, further comprising signaling, in the video bitstream, the encoded current block.

18. The method of claim 16, further comprising:
when a global IBC mode is allowed for the current block, identifying a first set of criteria as the one or more criteria; and
when a global IBC mode is not allowed for the current block, identifying a second set of criteria as the one or more criteria.

19. The method of claim 16, further comprising:
when a global IBC mode is allowed for the current block, encoding the current block without considering whether the one or more characteristics of the current block meet the one or more criteria.

20. A non-transitory computer-readable storage medium storing a video bitstream that is generated by a video encoding method, the method comprising:
receiving video data comprising a plurality of blocks, including a current block;
when one or more characteristics of the current block meet one or more criteria:
encoding the current block using an intra block copy (IBC) mode; and
signaling, in the video bitstream, one or more indicators indicating IBC information for the current block; and
when the one or more characteristics of the current block do not meet the one or more criteria, not signaling the IBC information for the current block.
